(19) United States
(12) Patent Application Publication
(10) Pub. No.: US 2002/0091786 A1
(43) Pub. Date: Jul. 11, 2002

(54) Information distribution system and load balancing method thereof

(76) Inventors: Nobuhiro Yamaguchi, Hadano (JP); Hitoshi Ueno, Atsugi (JP); Akio Yamamoto, Sagamihara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/985,111

(22) Filed: Nov. 1, 2001

(30) Foreign Application Priority Data
Nov. 1, 2000 (JP) 2000-334358

(51) Int. Cl. G06F 15/173; G06F 15/167; G06F 15/16

(52) U.S. Cl. 709/213; 709/225; 709/205

(57) ABSTRACT

In a logical partitioning system, a Web server program is executed on each of several logical partitions, the load on each of the logical partitions is monitored, and when a logical partition is overloaded, data being distributed by the logical partition is automatically switched for distribution by another logical partition that has spare capacity to accommodate the load, whereby load balancing is carried out.

### FIELD OF THE INVENTION

The present invention relates to a load balancing method for computer systems, more particularly to a load balancing process for providing data from a plurality of servers to respective clients in a client-server computing system.

### BACKGROUND OF THE INVENTION

An example of a client-server data provision system using a computer system is a system for distributing data via the Internet. One of the methods of distributing data is to execute Web server programs that distribute home pages constituted of information to be written on a screen according to a page-description language such as HTML, and image data such as GIF data. The data is received via the Internet by executing a Web client program that receives and displays home page data in a computer system on the Internet, and accessing a computer system that executes a Web server program to distribute the required home page data.

In these systems, the increasing number of Internet users and the burgeoning amount of home page data make the design of computer systems for executing Web server programs more complex. This is because Internet users throughout the world access Web server programs and request data with different timing requirements, so the access load on the Web server programs changes irregularly and drastically.

One method of reducing access load on Web server programs uses mirrored Web servers; this method distributes home page data with the same contents from Web server programs on a plurality of computer systems, thereby reducing the access load on the Web server program on each computer system.

Typical methods of accommodating load variations include addition of new processors and memory expansion during the operation of a computer system.

As a method of adding a new processor during the operation of a computer system, the method described in JP-A No. H7-281022 “A Method of Recovery from Fixed Failures of Processors” can be used; this method integrates a new processor into a computer system to improve the physical performance of the computer, thereby accommodating load variations without suspending operation of the computer system.

As a memory expansion method, the method described in JP-A No. H5-265851 “A Method of Reconstructing Memory Regions” can be used; this method incorporates new memory to expand the memory region of a physical computer system, thereby accommodating load variations without suspending the computer system.

### SUMMARY OF THE INVENTION

In these conventional methods, the following problems remain to be solved.

The first problem is in that it is impossible for the prior art to respond in real time to an unexpected drastic increase in access load on computer systems that execute Web server programs.

The second problem is that any addition, update, or modification made to the contents of the home page data stored at one of the computer systems in a mirrored Web server system must be transferred from that Web server to the mirrored Web servers via the Internet, requiring much time and placing an extra burden on the Internet.

The third problem is in that when an addition, update, or modification is made to the contents of home page data stored by each of the computer systems of the mirrored Web servers, the changes must be carried out on different computer systems that are situated apart from each other on the network, resulting in enormously increased cost of administrating the mirrored Web servers.

A first object of the present invention is to respond in real time to an unexpected abrupt increase in access load on computer systems that execute Web server programs, and perform balancing of the access load.

A second object of the present invention is to make additions, updates, and modifications to the contents of home page data held by each of the computer systems running mirrored Web servers faster, and without placing an extra burden on the Internet.

A third object of the present invention is to simplify control over additions, updates, and modifications to the contents of the home page data held by each of the computer systems on which the mirrored Web servers operate.

In order to achieve these objects, the present invention utilizes a logical partition system by using a single physical computer as a plurality of logical partitions and executing Web server programs in each of the logical partitions. This logical partition system comprises one or more logical partition groups having two or more logical partitions that distribute the same home page data, and monitors the load on each of the logical partitions; when a logical partition becomes overloaded, data being distributed by the logical partition is automatically switched for distribution by another logical partition that has spare capacity to accommodate the load, whereby load balancing is implemented for a logical partition group that becomes overloaded.

### BRIEF DESCRIPTION OF THE DRAWINGS

FIG. 1 is a drawing showing an embodiment of a load-balancing Web server using logical partitions according to the present invention.

FIG. 2 is a flow diagram (1) showing the processing of a load-balancing Web server using logical partitions according to the present invention.

FIG. 3 is a flow diagram (2) showing the processing of a load-balancing Web server using logical partitions according to the present invention.

FIG. 4 is a flow diagram (3) showing the processing of a load-balancing Web server using logical partitions according to the present invention.

FIG. 5 is a flow diagram (4) showing the processing of a load-balancing Web server using logical partitions according to the present invention.

FIG. 6 is a flow diagram (5) showing the processing of a load-balancing Web server using logical partitions according to the present invention.

FIG. 7 is a diagram showing the memory structure of a load-balancing Web server using logical partitions.

FIG. 8 is a flow diagram showing a method of accessing memory shared among logical partitions.

FIG. 9 is a diagram showing an entry in a table in which the LPAR (logical partition) number, the LPAR overload flag, the minimum load LPAR flag, the type of home page data, the load data, and the maximum access count of each LPAR are stored.

FIG. 10 is a diagram showing the structure of a floating address register (FAR).

FIG. 11 is a diagram showing a register that is required to count the number of accesses to each LPAR.

FIG. 12 is a drawing showing the structure of a shared memory region.

FIG. 13 is a diagram showing the structure of hardware for practicing the present invention.

FIG. 14 is a diagram showing an entry in a URL table that associates an LPAR number and a URL.

### DESCRIPTION OF A PREFERRED EMBODIMENT

An embodiment of the present invention will be described in detail with reference to the drawings.

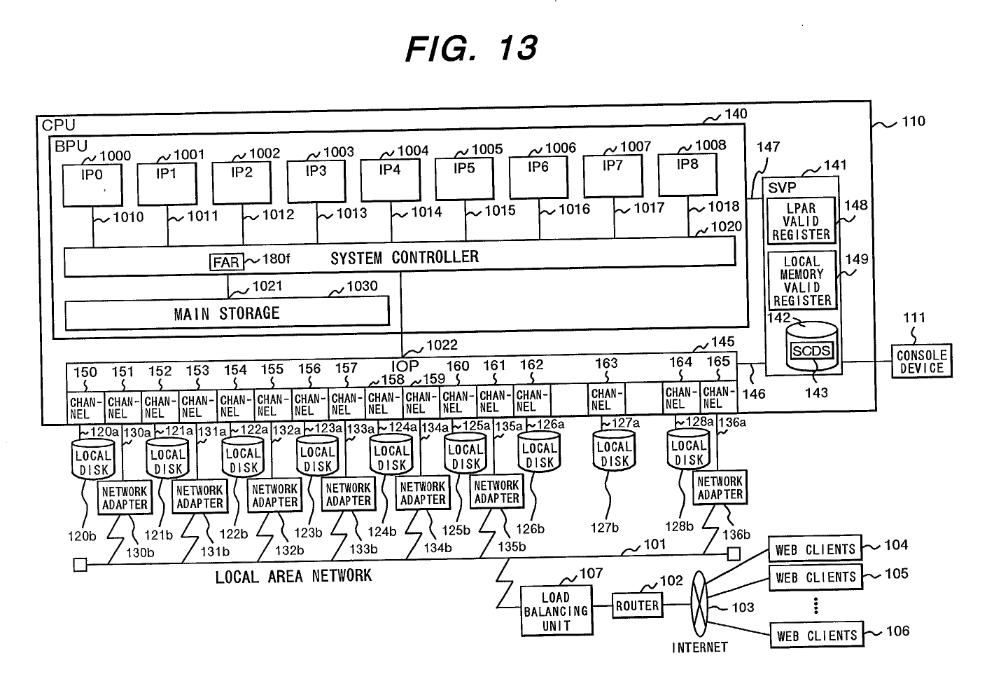

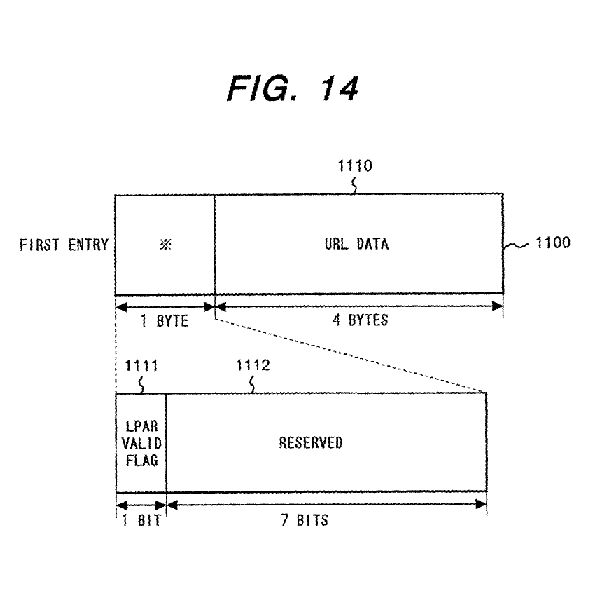

FIG. 13 shows the structure of hardware (CPU) 110 embodying the present invention and a state in which the hardware 110 is connected via the Internet to Web clients 104 to 106. The CPU 110 has a plurality of instruction processors 1000 to 1008 (each of which is referred to as an IP below) for processing program instructions. Although this drawing shows nine IPs, an information system may have more IPs, on each of which one or more logical partitions operate.

The individual IPs are linked to a system controller 1020 via paths 1010 to 1018. The system controller 1020 is linked via a path 1021 to a main storage 1030 that stores the codes of programs executed by the IPs and data used in the programs. The system controller 1020 has a function of processing memory requests from the plurality of IPs; each IP obtains required data through the system controller 1020. The system controller 1020 is linked via a path 1022 to an I/O processor 145, and the I/O processor 145 is linked via a plurality of channels 150 to 165 to local disks 120b to 128b and network adapters 130b to 136b. The channels 150 to 165 can be connected to storage devices other than local disks and I/O devices other than network adapters.

As described later, the I/O processor 145 controls the channels for each IP to access the corresponding local disks and network adapters, based on system configuration data (SCDS) 143 entered by the system administrator from a console device 111 and set by a service processor (SVP) 141, and logically links the IPs to the local disks and network adapters.

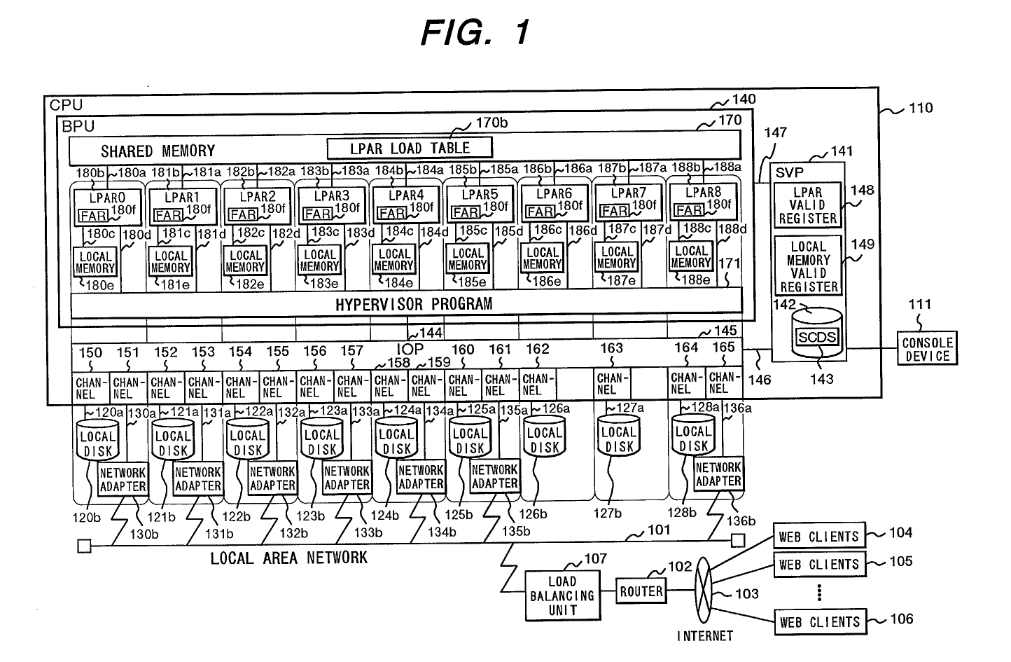

FIG. 1 shows the structure of a load-balancing Web server using a plurality of logical partitions that operate on the hardware (CPU) 110, and the connection structure of the load-balancing Web server and the Web clients 104 to 106 via the Internet 103.

Logical partitions (abbreviated as LPARs below) LPAR0 180b to LPAR8 188b operate respectively on IPO 1000 to IP8 1008 shown in FIG. 13. The logical partitions, LPAR0 180b to LPAR5 185b and LPAR8 188b, are linked via the corresponding network adapters 130b to 136b to a local area network 101 which is linked to the Internet 103 via a router 102 for relaying information to the Internet therefrom.

Here, the Web server system is an example of an information service system, which, in response to a request from a user, distributes requested data to the requester. A unit for distributing information, including an LPAR, the information distribution program executed thereon, and a local disk linked thereto, is referred to as an information distribution unit. A Web client is a form of user equipment.

The Internet 103 has connections with the plurality of Web clients 104 to 106 accessing the LPAR load-balancing Web server.

A hypervisor program 171, which is a control program for controlling a single physical computer to operate as a plurality of LPARs, operates on the LPAR load-balancing Web server, and a separate operating system (OS) operates on each LPAR under control thereof. Although the drawing schematically shows that the hypervisor program 171 and the logical partitions, LPAR0 180b to LPAR8 188b, are linked by logical paths 180d to 188d, in reality, when an LPAR issues a command by way of the hypervisor program 171, for the purpose of using hardware, for example, the hypervisor program 171 is executed on the one of the IPs 1000 to 1008 corresponding to the LPAR that issued the command.

Although this embodiment uses a plurality of logical partitions to execute a plurality of Web server programs, as an alternative method, the Web server programs can respectively be executed in a plurality of processes under control of a single OS.

In the embodiment of an LPAR load-balancing Web server shown in FIG. 1, initially, eight logical partitions, LPAR0 180b to LPAR7 187b, operate under control of the hypervisor program 171. The LPAR8 188b, which is required when the number of LPARs is increased, is present in a non-operating condition.

The LPAR load-balancing Web server comprises a shared memory 170 using a partial region of the main storage 1030 that is linked via logical paths 180a to 188a to the logical partitions LPAR0 180b to LPAR8 188b; the I/O processor (IOP) 145 that controls the channels 150 to 165 and is linked via a logical path 144 to the hypervisor program 171; the channels 150 to 165 that are controlled by the I/O processor (IOP) 145; and the local disks 120b to 128b, which are linked to channels 150, 152, 154, 156, 158, 160, 162, 163, and 164 via paths 120a to 128a. The shared memory 170 is used in common by the logical partitions LPAR0 180b to LPAR8 188b, while local memories 180e to 188e and the local disks 120b to 128b are used independently by the respective LPARs. The LPAR load-balancing Web server further comprises the network adapters 130b to 136b, which is linked via paths 130a to 136a to the channels 151, 153, 155, 157, 159, 161, and 165 that are used by the logical partitions LPAR0 180b to LPAR5 185b and LPAR8 188b, to enable each of these logical partitions, LPAR0 180b to LPAR5 185b and LPAR8 188b, to be linked to the network.

Logical partitions LPAR0 180b to LPAR5 185b execute Web server programs that distribute home page data constituted of data written according to a page-description language, such as HTML data, and image data such as GIF data to the Web clients 104 to 106. The Web server programs are stored in the local memories 180e to 185e used respectively by logical partitions LPAR0 180b to LPAR5 185b, and the home page data is stored in the local disks 120b to 125b used respectively by logical partitions LPAR0 180b to LPAR5 185b. Home page data is stored in a local disk 142 of the service processor (SVP) 141; at system start-up, the service processor (SVP) 141 transfers data from its local disk 142 to the local disks 120b to 125b of respective LPARs based on information entered from the console device 111 by the system administrator giving LPAR numbers and the types of home page data distributed by the LPARs with those numbers. Storage of the home page data is not limited to the local disk 142 in the service processor (SVP) 141; a storage device external to the system can be used instead. In this case, the service processor (SVP) 141, or each of the logical partitions LPAR0 180b to LPAR5 185b, or a single LPAR, references the LPAR load table 170b described below in the shared memory 170 and requests data transfer from the storage device.

A load balancing unit 107 is provided between the Web clients 104 to 106 and LPARs. The load balancing unit 107 comprises a URL table (FIG. 14) including URLs (Uniform Resource Locators) giving the addresses of the home page data distributed by each LPAR. Each entry 1100 in the URL table is generated in correspondence with an LPAR number, and stores an LPAR valid flag 1111 that indicates whether the LPAR is active or not, as well as the URL data 1110 of home page data to be distributed by the LPAR. The load balancing unit 107 compares the URLs of home page data in distribution requests made by the Web clients 104 to 106 with each of the URLs of home page data held by the LPARs; the distribution request is sent to the LPAR holding the matching URL. If there are a plurality of LPARs holding the matching URL, these LPARs are selected sequentially or randomly, for example, to prevent load from concentrating on a single LPAR.

The load balancing unit 107 has to provide a function of uniquely associating URLs requested by Web clients 104 to 106 with the IP addresses of the logical partitions LPAR0 180b to LPAR8 188b. Therefore, the load-balancing unit 107 may function in association with a domain name system (DNS) server, for example, but the description given herein will be limited to noting only that information associating the URLs with the LPARs is required, as shown in the URL table in FIG. 14.

LPAR6 186b executes an application program that performs required processing of messages sent from the Web clients 104 to 106 through the Internet 103 and received by the Web server programs in logical partitions LPAR0 180b to LPAR5 185b. The messages received by these logical partitions LPAR0 18Ob to LPAR5 185b, are transferred via the shared memory 170 to LPAR6 186b.

When a shared memory is used for LPAR-to-LPAR data transfer, the data transfer throughput that can be obtained is several times higher than that obtainable by use of the local area network 101. Therefore, LPAR-to-LPAR Web data mirroring can be achieved in a shorter time.

LPAR7 187b executes a database server program that performs database processing when the application program running on LPAR6 186b needs to consult or update a data base in response to messages from the Web clients 104 to 106. Database-processing requests from LPAR6 186b are transferred via the shared memory 170 to LPAR7 187b.

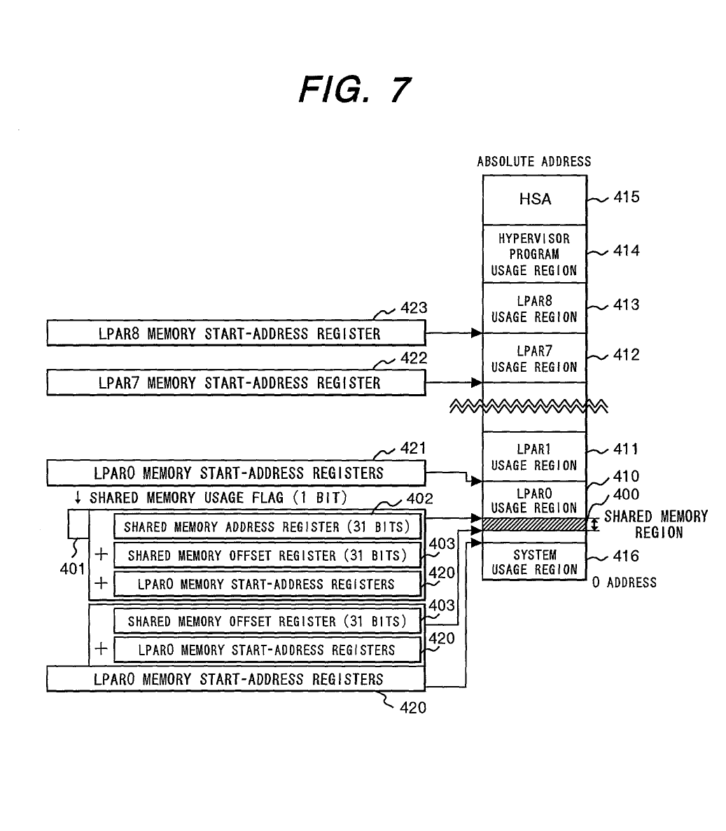

FIG. 7 shows the usage of the main storage 1030 in the LPAR load-balancing Web server.

The highest memory region is a hardware system area (HSA) 415 used by hardware for system administration, and the region following the hardware system area (HSA) 415 is a hypervisor program usage region 414.

The LPAR load-balancing Web server uses memory start-address registers 420 to 423, which define the memory start-address for each LPAR, to allocate a usage region in units of up to 2 GB for each LPAR, beginning at address 0. Note that, if necessary, the memory region from address 0 to the address in LPAR0 memory start-address register 420 can be allocated as a system usage region 416.

In order to implement sharing of the shared memory 170 among the LPARs, this embodiment provides each LPAR with a shared memory usage flag 401 that is set to ‘1’ when the LPAR uses the shared memory 170, a shared memory offset register 403 that indicates the start address of the shared memory 170, and a shared memory address register 402 that indicates the size of the shared memory 170. The shared memory 170 uses a shared memory region 400 of the main storage 1030; this is the region between an address obtained by summing the values of the LPAR0 memory start-address register 420 and the shared memory offset register 403, and an address obtained by summing the values of the LPAR0 memory start-address register 420, the shared memory offset register 403, and the shared memory address register 402.

FIG. 12 shows the structure of the shared memory 170. The shared memory 170 can be expanded in 16-Mbyte units, each consisting of 4095 4-Kbyte shared memory blocks accessible by each LPAR (shared memory block 0 900 to shared memory block 4094 902) and an exclusive control block 0 903 that holds 1 byte of exclusive control information for each shared memory block. In the exclusive control information indicating the usage of a shared memory block, the most significant bit is set to ‘1’ when the shared memory block is being used by another LPAR.

Since the exclusive information block 0 903 is disposed at the top of the 16-Mbyte region, the most significant bit of the top byte in the 16-Mbyte region, indicating usage of the exclusive control information of the exclusive control block 0 903, should be set to ‘0’.

The shared memory offset register 403 is a 31-bit register in which the offset value of the LPAR0 usage region 410 of the shared memory 170 is set, as shown in FIG. 7.

The shared memory address register 402 is a 31-bit register giving the value obtained by subtracting ‘1’ from the number of 16-Mbyte units.

The values of the shared memory offset register 403 and shared memory address register 402 are entered from the console device 111 of the service processor (SVP) 141 when the computer system is initialized, and are stored by the service processor (SVP) 141.

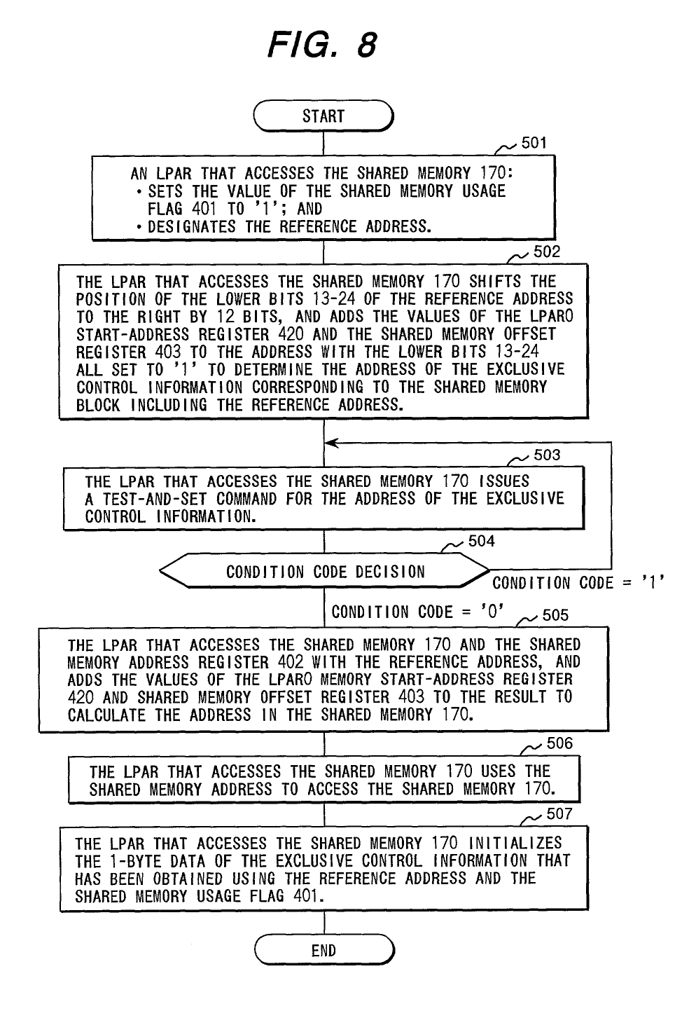

FIG. 8 shows how the shared memory 170 is accessed. An LPAR that accesses the shared memory 170 sets the value of the shared memory usage flag to ‘1’, and designates the address to be referenced (the reference address) (Step 501). The LPAR that accesses the shared memory 170 shifts the position of the lower bits 13-24 to the right by 12 bits, and adds the value of the LPAR0 start-address register 420 and the shared memory offset register 403 to the address with the lower bits 13-24 all set to ‘1’ to determine the address of the exclusive control information corresponding to the shared memory block including the address to be referenced (Step 502).

The LPAR issues a test-and-set command for the address of the exclusive control information to set a condition code to ‘0’ if the most significant bit is ‘0’ or to ‘1’ if the most significant bit is ‘1’, then set all bits of 1 byte of the referenced address to ‘1’ (Step 503). The LPAR examines the condition code (Step 504), and if the condition code is ‘1’ returns to Step 503 to issue a test-and-set command again. If the condition code is ‘0’, the LPAR ANDs the value of the shared memory address register 402 with the reference address, adds the values of the LPAR0 memory start-address register 420 and shared memory offset register 403 to the result to calculate the address in the shared memory 170 (Step 505), and accesses the shared memory 170 (Step 506). Finally, the LPAR initializes the 1 byte of exclusive control information that has been obtained using the reference address and the shared memory usage flag 401 (Step 507).

The method of accessing the shared memory 170 is used to define a copy common memory (CPCM) command to copy data from the local disks 120b to 128b to the shared memory 170, and a move common memory (MVCM) command to move data from the shared memory 170 to the local disks 120b to 128b.

The LPAR load-balancing web server shown in FIG. 1 comprises a basic processing unit (BPU) 140, the service processor (SVP) 141, which is linked to the I/O processor (IOP) 145 via paths 146 and 147, and the console device 111 of the service processor (SVP) 141, which is linked to the service processor by a path 148. The service processor (SVP) 141 has an internal local disk 142. The service processor (SVP) 141 sets the configurations of logical partitions LPAR0 180b to LPAR8 188b, local memory 180e to 188e, the shared memory 170, I/O processor (IOP) 145, and the channels 150 to 165; the local disk 142 in the service processor (SVP) 141 stores a system configuration data set (SCDS) 143 that defines the configuration of the channels 150 to 165. This embodiment includes a process of adding LPAR8 188b to balance the load of accesses from the Web clients 104 to 106, so to be ready for an increase in the number of channels used, in response to the addition of LPAR8 188b, a system configuration data set (SCDS) including channels 164 and 165, which may be added in the future, is prepared and stored in the local disk 142 of the service processor (SVP) 141.

A channel that is physically connected to a computing system is referred to as being installed; the connection information is recorded in the system configuration data set (SCDS) 143. A channel that is not physically connected to a computer system is referred to as being not-installed. Installed channels can be switched between the enabled state and disabled state under the control of the service processor (SVP) 141. The enabled state refers to the state in which a device is logically connected; the disabled state refers to a state in which a device is logically disconnected. LPAR8 188b serves as an LPAR that can be added for load balancing when the capacity of the other LPARs is exhausted. The channels 164 and 165 used by LPAR8 188b start operations in response to load, so they are initially in the disabled state; therefore, the local disk 128b that is linked to channel 164 via path 128a and the network adapter 136b that is linked to channel 165 via path 136a are in the disabled state. Similarly, the local memory 188e that is linked via path 188c to LPAR8 188b starts operation in response to load, so it is in the disabled state in the LPAR load-balancing Web server system.

The service processor (SVP) 141 has an LPAR valid register 148 that switches the logical partitions LPAR0 180b to LPAR8 188b between the enabled and disabled states; when a value in the LPAR valid register is ‘1’, the corresponding LPAR is enabled. The service processor (SVP) 141 has a local memory valid register 149 that switches the local memories 180e to 188e between the enabled and disabled states; when a value in the local memory valid register 149 is ‘1’, the corresponding local memory is enabled. Switching the local memory valid register 149 alters the contents of a floating address register (FAR) 180f that converts absolute addresses used in the LPAR'S program to physical addresses in the storage device, thereby switching the local memory to the enabled or disabled state.

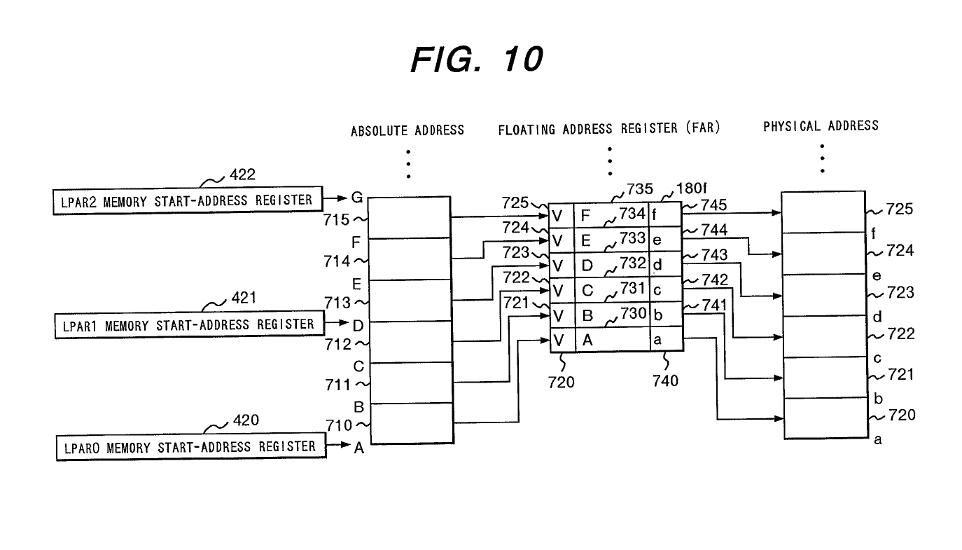

FIG. 10 shows the control process used to enable and disable the local memories 180e to 188e by switching the local memory valid register 149 and altering the floating address register (FAR) 180f.

The start addresses of absolute address of the address conversion units, stored in the floating address register (FAR) 180f, are defined as A, B, C, D, E, F, and G; the local memory 180e of LPAR0 180b uses the main storage regions designated by the start addresses of absolute address A, B, and C; the local memory 181e of LPAR1 180b uses the main storage regions designated by the star addresses of absolute address D, E, and F. The main storage regions used by the local memories 180e and 181e are determined by respective LPAR memory start address registers 420 to 422. The floating address register (FAR) 180f comprises start addresses of the absolute address 730 to 735 for the address conversion units, start addresses of the physical addresses 740 to 745, and valid bits 720 to 725 that indicate the enabled or disabled state of the respective address conversion units. The value of the valid bit is set to ‘1’ when the storage device is enabled and is set to ‘0’ when the storage device is disabled. In the example shown in FIG. 10, the absolute address (A) 730 is converted to the respective physical address (a) 740, and the enabled or disabled state is indicated by the valid bit 720. If the value of the local memory valid register 149 that is set for each local memory owned by each LPAR is set in all conversion unit valid bits in the floating address register (FAR) 180f used by the respective local memory, the local memory can then be enabled or disabled.

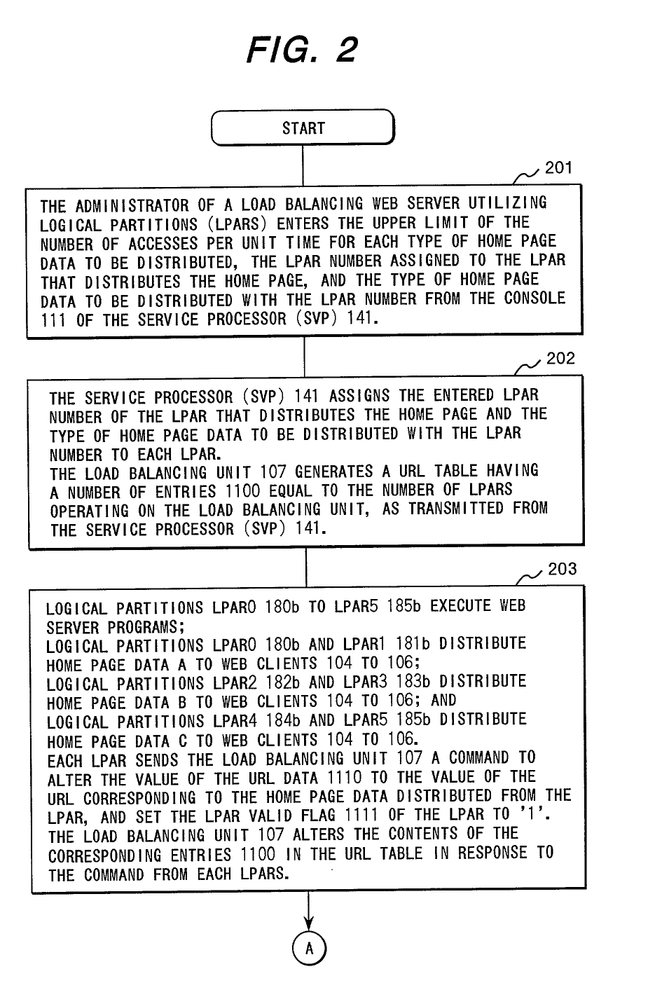

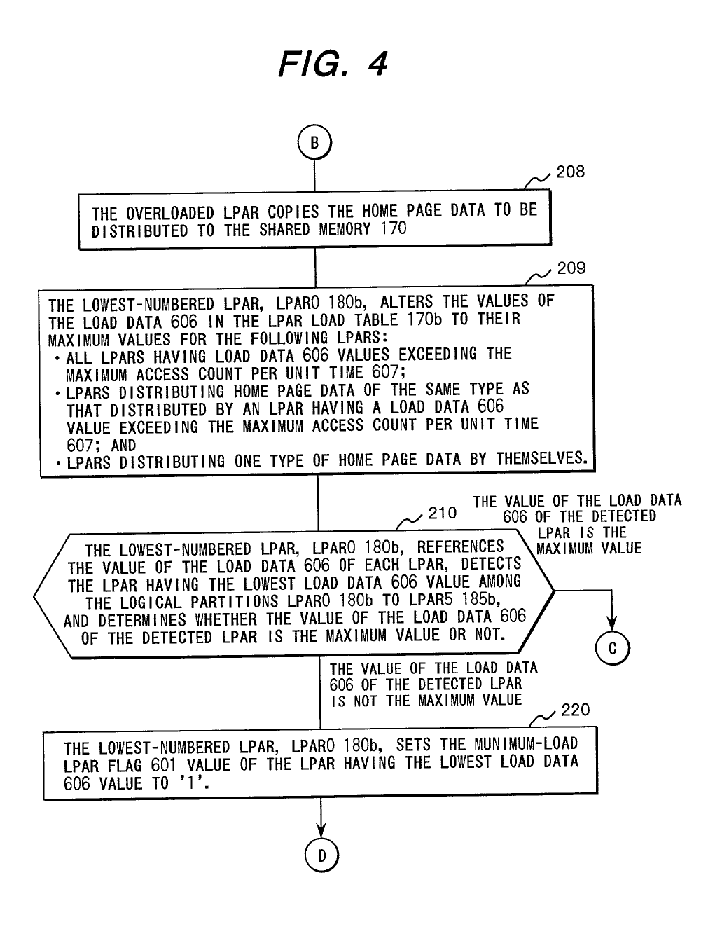

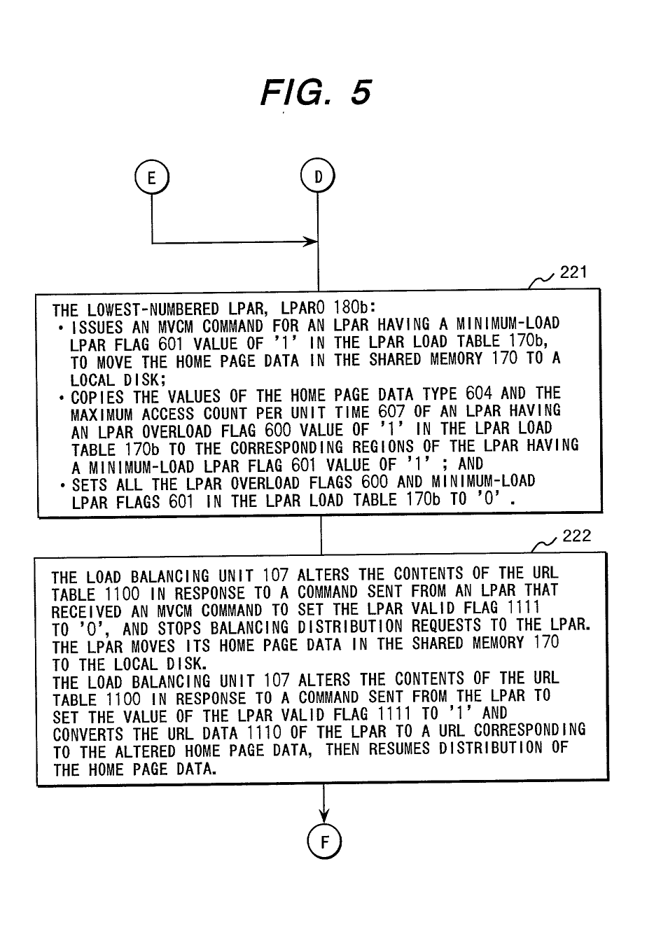

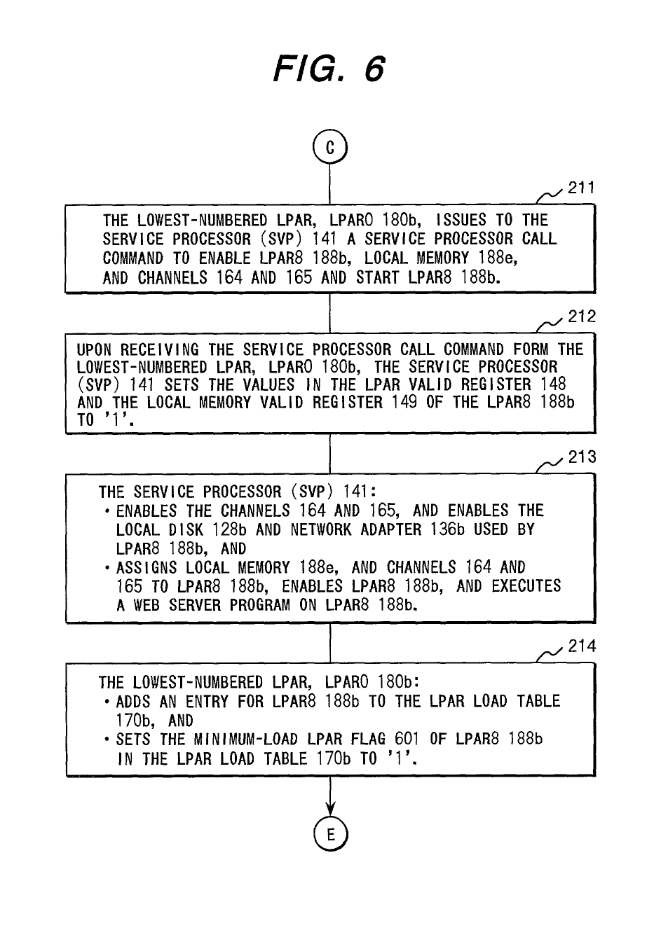

FIGS. 2 to 6 are flow diagrams describing the operation of an LPAR load-balancing Web server. From the consol 111 of the service processor (SVP) 141 shown in FIG. 1, the administrator of the LPAR load-balancing Web server defines the types of the home page data to be distributed according to the means of accessing various information resources (communication protocols to be used) on the Internet 103, defines server names according to the uniform resource locator (URL) specification that stipulates how the resource names are specified, enters an upper limit of the number of accesses per unit time (referred to as a maximum access count below), and enters an LPAR number of the LPAR by which the type of the home page data is distributed. The load-balancing Web server reads in this information (Step 201).

For each LPAR, if the LPAR corresponds to an LPAR number entered from the console device 111, the service processor (SVP) 141 sets the home page data types entered in correspondence to that LPAR number. The service processor (SVP) 141 transmits the number of LPARs that operate on the load balancing unit 107 to the load balancing unit 107. The load balancing unit 107 receives the number of LPARs and generates a URL table 1100 having a number of entries equal to the number of LPARS operating on the load balancing unit. At this time, the LPAR valid flags 1111 are all set to ‘0’ (Step 202).

An LPAR assigned by the service processor (SVP) 141 to distribute a type of home page data stores the home page data in the respective local disk 120b to 128b, for distribution by the Web server program executed on the LPAR. If A is entered from the console device 111 as the type of home page data to be distributed by the LPARs with LPAR numbers 0 and 1, the Web server programs running on LPAR0 180b and LPAR1 181b store home page data A in local disks 120b and 121b, and distribute the home page data to the Web clients 104 to 106 when they access LPAR0 180b or LPAR1 180b.

Similarly, if B is entered as the type of home page data for LPAR numbers 2 and 3 and C is entered as the type of home page data for LPAR numbers 4 and 5, the Web server programs running on LPAR2 182b and LPAR3 183b store home page data B in local disks 122b and 123b, and the Web server programs running on LPAR4 184 and LPAR5 185 store home page data C in the local disks 124b and 125b. Each LPAR that performs distribution sends the load balancing unit 107 a command to set the values of the URL data and set the LPAR valid flag 1111 to ‘1’. When the load balancing unit 107 receives the command and modifies the data of the entry corresponding to the LPAR number of the sender LPAR, the LPAR becomes able to receive home page data distribution requests from the Web clients 104 to 106. The Web server program running on each LPAR distributes the home page data stored by the LPAR to Web clients accessing the LPAR (Step 203).

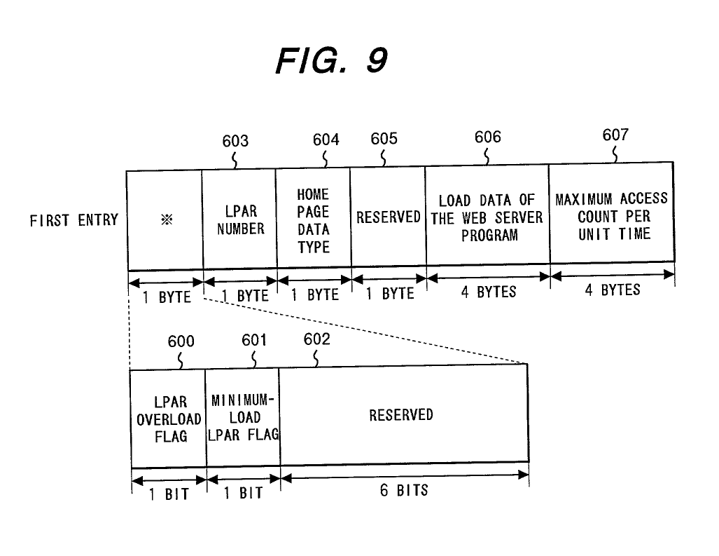

FIG. 9 is a drawing showing the structure of an entry of an LPAR load table 170b. An entry is 12 bytes long: the first 1 bit stores an LPAR overload flag 600, the next 1 bit stores a minimum-load LPAR flag 601, the following 6 bits are reserved 602, the next 1 byte stores an LPAR number 603, the next 1 byte stores the type of home page data 604 of the LPAR designated by the LPAR number 603, the next 1 byte is reserved 605, the next 4 bytes store the load data 606 of the Web server program running on the LPAR designated by the LPAR number 603, and the remaining 4 bytes store the maximum access account per unit time 607 for the type of home page data 604.

The lowest-numbered LPAR, LPAR0 180b, manages the load on the Web server programs of LPAR0 180b to LPAR5 185b, and generates a table (referred to as the LPAR load table 170b below) comprising the LPAR number 603, the load data 606 of a Web server program to be run on the LPAR designated by the LPAR number, the type of home page data 604 being distributed by the Web server program being executed on the LPAR designated by the LPAR number, the maximum number of accesses to the type of home page data per unit time 607, the LPAR overload flag 600 that is set to ‘1’ on a load balancing request for the Web server program of the LPAR designated by the LPAR number, and a minimum-load LPAR flag 601 that is set to ‘1’ on a modification request for the type of home page data to be distributed. The service processor (SVP) 141 stores in the LPAR load table 170b the values of the LPAR number 603 that was entered by the administrator, the type 604 of home page data being distributed by the Web server program running on the LPAR designated by the LPAR number, and the maximum number of accesses to the type of the home page data per unit time 607 (Step 204). The load data 606 of the Web server program running on each LPAR is stored by the respective LPAR later, so it is not stored at this point. The LPAR load table 170b has an entry for each LPAR on which the Web server program is executed.

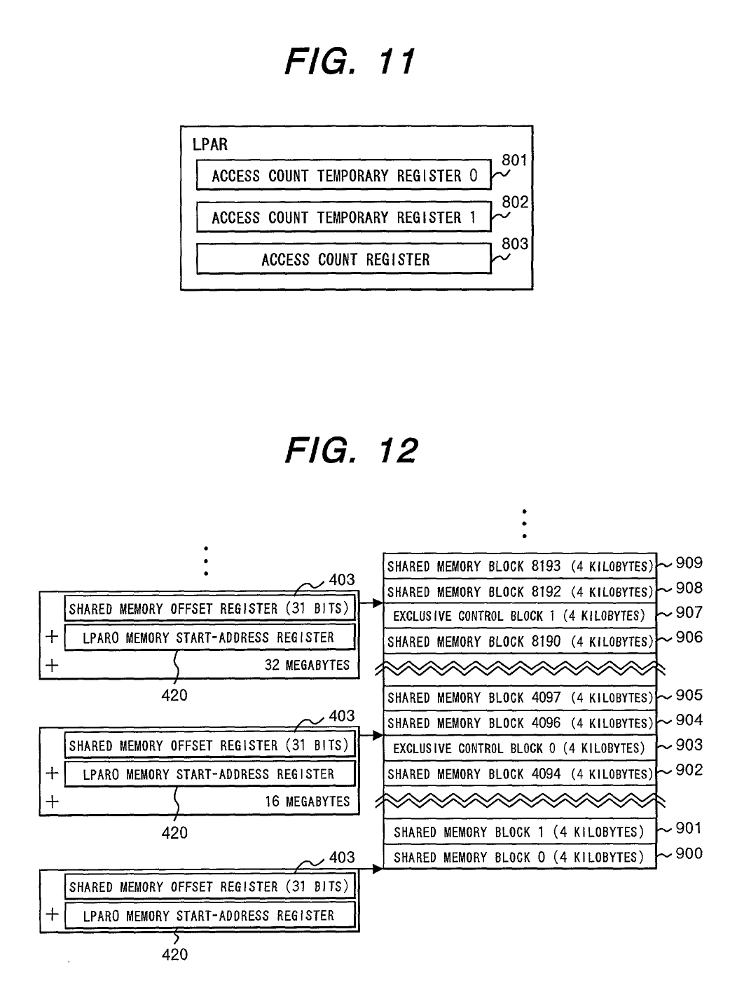

The registers that are necessary for calculating the number of access to the Web server program for each LPAR per unit time are shown in FIG. 11 and the calculation method will be described below. An access count temporary register 0801, an access count temporary register 1 802, and an access count register 803 that stores the difference between the value of the access count temporary register 1 802 and the value of the access count temporary register 0 801 before and after a unit of time are provided for each LPAR.

Each Web server program for the respective logical partitions LPAR0 180b to LPAR5 185b stores the number of accesses to the Web server program in the access count temporary register 0 801. A line of access information is added to the access log of the Web server program at each access to the Web server program, so the access count can be determined by counting the number of lines in the access log. After a unit time interval, each Web server program for logical partitions LPAR0 180b to LPAR5 185b stores the number of accesses to the Web server program in access count temporary register l 802. The Web server program calculates the difference between the value of access count temporary register 1 802 and the value of access count temporary register 0 801, and stores the result in the access count register 803. The logical partitions LPAR0 180b to LPAR5 185b store the contents of the respective access count register 803 in the region giving the load data 606 for the LPAR in the LPAR load table 170b (Step 205).

The lowest-numbered LPAR, LPAR0 180b, compares the value of the load data 606 with the value of the maximum access count per unit time 607 for each of the logical partitions LPAR0 180b to LPAR5 185b.

If the comparison result shows no LPAR having load data 606 exceeding the maximum access count per unit time 607, LPAR0 180b returns to Step 205 and continues processing.

If an LPAR having load data 606 exceeding the value of the maximum access count per unit time 607 (referred to as an overloaded LPAR below) exists, the lowest-numbered LPAR, LPAR0 180b, issues a CPCM command to copy the home page data being distributed by the overloaded LPAR to the shared memory 170, and sets the LPAR overload flag 600 of the LPAR in the LPAR load table 170b to ‘1’ (Step 207).

The overloaded LPAR that received the CPCM command from the lowest-numbered LPAR, LPAR0 180b, copies its distribution home page data to the shared memory 170 via a path provided therebetween (Step 208) In the case of a plurality of overloaded LPARs, the process is performed for the lowest-numbered LPAR among them.

The lowest-numbered LPAR, LPAR0 180b, alters the values of the load data 606 of all LPARs having load data 606 exceeding the value of the maximum access count per unit time 607 to the maximum values. This is done to prevent an LPAR in which load on the Web server program exceeds the maximum permissible amount from being selected as the minimum-loaded LPAR.

The lowest-numbered LPAR, LPAR0 180b, references the type of home page data to be distributed by the LPAR having a load data 606 value exceeding the value of the maximum access count per unit time 607 in the LPAR load table 170b, detects an LPAR that distributes the same type of home page data as distributed by the excessively loaded LPAR, and alters the load data 606 value of the detected LPAR to the maximum value. This alteration is done to prevent an LPAR that distributes the same type of home page data as distributed by the LPAR in which the load on the Web server program exceeds the maximum permissible amount from being selected as a minimum-loaded LPAR.

The lowest-numbered LPAR, LPAR0 180b, references the types of home page data of the logical partitions LPAR0 180b to LPAR5 185b in the LPAR load table 170b, detects any LPAR that distributes a single type of home page data by itself, and alters the load data 606 value of the detected LPAR to the maximum value. This alteration is done to prevent the LPAR from being selected as a minimum-loaded LPAR (Step 209).

The lowest-numbered LPAR, LPAR0 180b, references the LPAR load table 170b, detects an LPAR with the lowest load data 606 value among the logical partitions LPAR0 180b to LPAR5 185b, and decides whether the load data 606 value of the detected LPAR is the maximum value or not. If there are two or more LPARs with the minimum load data 606 value, the process is performed for the lowest-numbered LPAR (Step 210).

If the load data 606 value of the detected LPAR is the maximum value, a service processor call command is issued from the lowest-numbered LPAR, LPAR0 180b, to the service processor (SVP) 141 to enable LPAR8 188b, the local memory 188e that is linked via a path 188c to LPAR8 188b, and the channels 164 and 165, and to start up LPAR8 188b (Step 211).

When it receives the service processor call command from the lowest-numbered LPAR, LPAR0 180b, the service processor (SVP) 141 sets the values of the LPAR valid register 148 and local memory valid register 149 of the local memory 188e used by LPAR8 188b to ‘1’ (Step 212).

The service processor (SVP) 141 sets the configuration of the channels 150 to 165, and enables the local disk 128b used by LPAR8 188b and the channels 164 and 165 to which the network adapter 136b is linked. This enables the local disk 128b and the network adapter 136b.

The service processor (SVP) 141 assigns the local memory 188e and the channels 164 and 165 to LPAR8 188b, enables LPAR8 188b, and executes the Web server program on LPAR8 188b (Step 213).

The lowest-numbered LPAR, LPAR0 180b, adds an entry for LPAR8 188b to the LPAR load table 170b, and sets the minimum-load LPAR flag 601 of LPAR8 188b in the LPAR load table 170b to ‘1’ (Step 214).

The lowest-numbered LPAR, LPAR0 180b, references the LPAR load table 170b, detects an LPAR with the lowest load data 606 value among the logical partitions LPAR0 180b to LPAR5 185b, and if the load data 606 value of the detected LPAR is not the maximum value, sets the minimum-load LPAR flag 601 of the LPAR having the lowest load data 606 value to ‘1’. If there are a plurality of LPARs with the lowest load data 606 value, the process is performed for the lowest-numbered LPAR (Step 220).

The lowest-numbered LPAR, LPAR0 180b, issues an MVCM command for an LPAR having a minimum-load LPAR flag 601 of ‘1’ in the LPAR load table 170b to move the home page data in the shared memory 170 to a local disk; copies the values of the home page data type 604 and the maximum access count per unit time 607 of an LPAR having an LPAR overload flag 600 of ‘1’ in the LPAR load table 170b to the corresponding fields of the LPAR having a minimum-load LPAR flag 601 of ‘1’; and sets all the LPAR overload flags 600 and minimum-load LPAR flags 601 in the LPAR load table 170b to ‘0’ (Step 221).

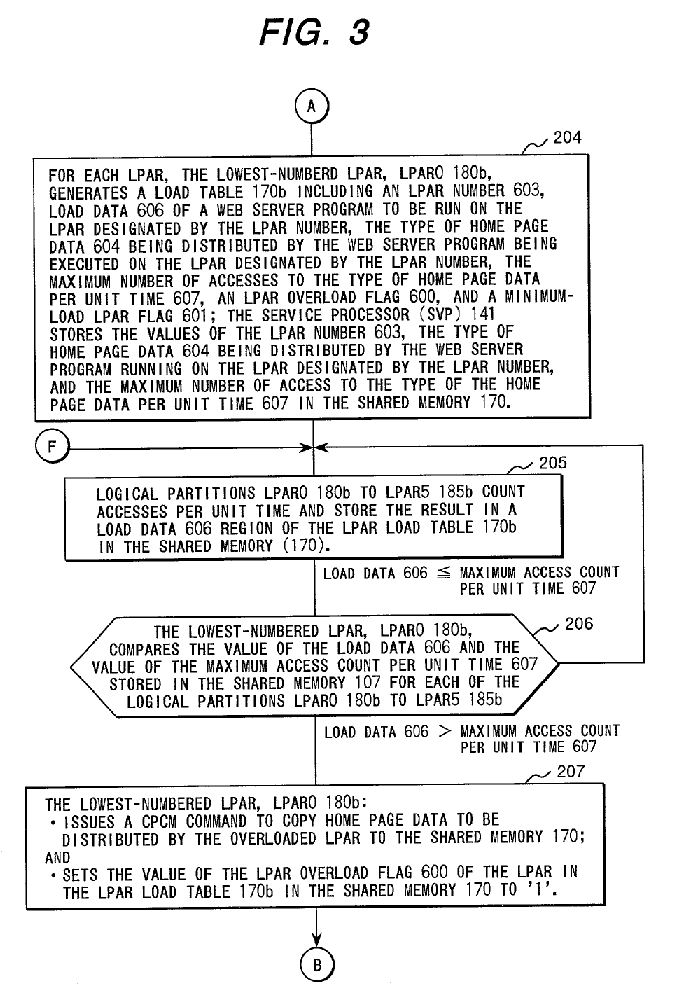

The LPAR that received the MVCM command sends the load balancing unit 107 a request to stop balancing distribution requests to the load balancing unit 107. The LPAR moves the home page data on the shared memory 170 to the local disk 142, and issues a command for the load balancing unit 107 to convert the URL data 1110 to a URL corresponding to the altered home page data. The load balancing unit 107 converts the data of the corresponding entry of the URL table 1100 in response to the command; then the LPAR resumes distribution of the altered home page data (Step 222). The LPAR returns to Step 205 in FIG. 3 to continue processing.

As described above, according to this embodiment, a plurality of logical partitions run; each logical partition executes a respective Web server program; in a logical partition system having two or more logical partition groups that distribute the same home page data, each logical partition monitors the load condition of the home page data being distributed, copies the home page data being distributed by a highly loaded logical partition group to a logical partition in a lightly loaded logical partition group at high speed by using a shared memory, whereby the number of logical partitions that distribute the home page data increases, enabling automated load balancing of home page data distribution. In addition, when each logical partition monitors the load condition of the home page data being distributed, if there is a highly loaded logical partition group distributing home page data, but there is no lightly loaded logical partition group to which home page data can be copied for load balancing for home page data distribution, a new logical partition can be added without halting the computer system, a Web server program can be executed thereon, and home page data being distributed by the highly loaded logical partition group can be copied at high speed to the new logical partition by using a memory shared among the logical partitions, whereby the number of logical partitions that distribute the home page data increases, enabling automated load balancing of the home page data distribution.

Furthermore, according to this embodiment, home page data is copied from one LPAR to another LPAR by using a memory shared among the logical partitions, so mirrored Web servers can be implemented and data can be copied between them faster than in the case of using the Internet, and without extra load on the Internet.

According to this embodiment, moreover, logical partitions on a single computer are used and the home page data to be distributed by the respective Web server programs is copied via a shared memory among the logical partitions, whereby faster and easy-to-control mirrored Web servers can be implemented, as compared to the case in which a plurality of computers are used and home page data is copied via the Internet.

According to the present invention, a plurality of logical partitions run; each logical partition executes a respective Web server program; in a logical partition system comprising one or more logical partition groups that include two or more logical partitions that distribute the same home page data, each logical partition monitors the load condition of the home page data being distributed, and copies the home page data being distributed by a highly loaded logical partition group to one of the logical partitions in a lightly loaded logical partition group by using a memory shared among the logical partitions, whereby the number of logical partitions increases, enabling automated load balancing of the home page data distribution.

What is claimed is:

1. An information distribution system comprising:
a plurality of information distribution units that distribute information as requested from users, which include one or more information distribution unit groups having at least two information distribution units capable of distributing the same information;
means for monitoring load on each of said information distribution units; and
means for transferring information held for distribution by an information distribution unit that is overloaded because its load exceeds a predetermined load to one of the information distribution units of said information distribution unit group, to enable the distribution of the same information as distributed by said overloaded information distribution unit.

2. An information distribution system comprising:
a plurality of logical partitions that distribute information requested from users;
a shared memory that is shared by said plurality of logical partitions;
means for monitoring the load on said logical partitions; and
means for transferring information that can be distributed by an information distribution unit that is overloaded because its load exceeds a predetermined load to a more lightly loaded logical partition via said shared memory.

3. An information distribution system comprising:
a plurality of logical partitions that distribute information requested from users and include one or more logical partition groups having at least two logical partitions that can distribute the same information;
a shared memory that is shared among said plurality of logical partitions;
means for monitoring load on each of said plurality of logical partitions; and
means for transferring information held for distribution by an information distribution unit that is overloaded because its load exceeds a predetermined load to a logical partition with spare capacity for accommodating the load via said shared memory, thereby making it possible to distribute the same information as the information held for distribution by said overloaded logical partition.

4. The information distribution system according to claim 1, wherein said load is determined from the number of accesses from users in a certain time interval.

5. The information distribution system according to claim 1, further comprising means of storing, wherein if an information distribution unit is overloaded because its load exceeds a predetermined load and there is no information distribution unit with spare capacity for accommodating the load, said means for storing stores information that can be distributed by said overloaded information distribution unit in an information distribution unit that has not distributed any information so far, thereby making it possible to distribute the information to the users.

6. The information distribution system according to claim 2, further comprising means for storing, wherein if a logical partition is overloaded because its load exceeds a predetermined load and there is no logical partition with spare capacity for accommodating the load, said means for storing stores information that can be distributed by said overloaded information distribution unit in an information distribution unit that has not distributed any information so far, thereby making it possible to distribute the information to the users.

7. An information distribution system comprising:
a plurality of logical partitions for executing respective Web server programs and distributing home page data requested from users, including one or more logical partition groups having at least two logical partitions that execute respective Web server programs and can distribute the same home page data;
a shared memory that is shared among the logical partitions;
means for monitoring load on each of said logical partitions and detecting overloaded logical partitions;
means for copying home page data of an overloaded logical partition via said shared memory to a minimum-loaded logical partition; and
means for altering the URL of said minimum-loaded logical partition to the same URL as that of said overloaded logical partition.

8. An information distribution system comprising:
a plurality of logical partitions that execute respective Web server programs and distribute home page data requested from users, including one or more logical partition groups having at least two logical partitions capable of executing Web server programs and distributing the same home page data;
a shared memory that is shared among the logical partitions;
a load table that is provided in said shared memory and stores load data indicating the load condition and a predetermined maximum load amount of each logical partition; a means, provided in one of said logical partitions, for comparing the value of said load data and the value of said maximum load amount to monitor the load on each logical partition, and when the value of said load data exceeds said maximum load amount, causing the logical partition to copy home page data being distributed by the overloaded logical partition to said shared memory; and
means for selecting a logical partition with spare capacity for accommodating the load among said plurality of logical partitions and causing the selected logical partition to acquire the home page data that has been copied to said shared memory.

9. An information distribution system comprising:
a plurality of logical partitions that execute respective Web server programs and distribute home page data requested from users, including one or more logical partition groups having at least two logical partitions capable of executing Web server programs and distributing the same home page data;
a shared memory that is shared among the logical partitions;
means for comparing the value of a predetermined maximum load amount with the value of load data per unit time to monitor the load on each logical partition, and when the value of said load data exceeds said maximum load amount, then causing the logical partition to copy home page data being distributed by the overloaded logical partition to said shared memory; and
means for selecting a logical partition with spare capacity for accommodating the load among said plurality of logical partitions, excepting a logical partition distributing a single type of home page data by itself, and causing the selected logical partition to acquire the home page data that has been copied to said shared memory.

10. An information distribution system comprising:
a plurality of logical partitions that execute respective Web server programs and distribute home page data requested from users, including one or more logical partition groups having at least two logical partitions capable of executing Web server programs and distributing the same home page data; a shared memory that is shared among the logical partitions;
a load table, provided in said shared memory for each logical partition, that stores the type of home page data distributed by the logical partition, load data indicating a load condition thereon, and a predetermined maximum load amount;
means, provided in one of the logical partitions, for comparing the value of the load data with the maximum load amount to monitor the load on each logical partition, and when the value of said load data exceeds said maximum load amount, then causing the overloaded logical partition to copy the home page data being distributed thereby to said shared memory;
means for setting the load data value in said load table for a logical partition having the same type of home page data as the home page data being distributed by said overloaded logical partition and the load data value in said load table for a logical partition that distributes a single type of home page data by itself to the maximum value; and
means for selecting a minimum-loaded logical partition among said plurality of logical partitions by referring the load tables and causing the selected logical partition to acquire the home page data that has been copied to the shared memory.

11. A load balancing method for an information distribution system having a plurality of information distribution units for distributing information requested by the users, comprising the steps of:
forming one or more information distribution unit groups that allow at least two of said information distribution units to distribute the same information;
monitoring the load on each of said information distribution units; and
transferring information held for distribution by an overloaded information distribution unit to one of the information distribution units in said information distribution unit group, when said overloaded information distribution unit is overloaded because its load exceeds a predetermined load and enabling distribution of the same information as distributed by said overloaded information distribution unit.

12. A load balancing method for an information distribution system having a plurality of logical partitions for distributing information requested by the users, comprising the steps of:
constructing a shared memory that is shared among said plurality of logical partitions;
monitoring a load on each of said logical partitions; and
transferring information that can be distributed by an overloaded logical partition via said shared memory to a more lightly loaded logical partition when said overloaded logical partition is overloaded because its load exceeds a predetermined load.

13. A load balancing method for an information distribution system, comprising the steps of:
forming one or more logical partition groups that allow at least two of said logical partitions to distribute the same home page data;
forming a shared memory that is shared among said plurality of logical partitions;
monitoring a load on each of said logical partitions; and
transferring information held for distribution by an overloaded logical partition via said shared memory to one of the logical partitions with spare capacity for accommodating the load in said logical partition group, thereby enabling the distribution of the same home page data as distributed by said overloaded logical partition when said overloaded logical partition is overloaded because its load exceeds a predetermined load.
